(19) United States
(12) Patent Application Publication
(10) Pub. No.: US 2010/0177190 A1
(43) Pub. Date: Jul. 15, 2010

(54) MICROSCOPY SYSTEM WITH REVOLVABLE STAGE

(76) Inventors: Ann-Shyn CHIANG, Hsin Chu City (TW); Hsiu-Ming Chang, Hsin Chu City (TW); Chia-He Chen, Kao-Hsiung City (TW); Chien-Chung Fu, Hsin Chu City (TW); Chang-Huain Hsieh, Hsinchu City (TW)

Correspondence Address: Muncy, Geissler, Olds & Lowe, PLLC, 4000 Legato Road, Suite 310, FAIRFAX, VA, 22033, US

(21) Appl. No.: 12/726,933

(22) Filed: Mar. 18, 2010

Related U.S. Application Data
(63) Continuation-in-part of application No. 12/336,306, filed on Dec. 16, 2008, now abandoned.

(51) Int. Cl. H04N 7/18; G02B 21/26; G02B 21/36

(52) U.S. Cl. 348/79; 359/393; 250/237 R; 348/E07.085

(57) ABSTRACT

A microscopy system includes an image focusing module, a stage for supporting a sample, image collection unit for collecting sliced images of the sample acquired by the image focusing module, and an image fusion unit for fusing sliced images of the sample acquired from different observation angles. The stage supports the sample and is configured to be revolvable around a rotational axis which is substantially perpendicular to an extending direction from the sample to the image focusing module so that enabling the image focusing module to acquire sliced images of the sample from different observation angles. The image fusion unit is used for remapping the sliced images acquired from different observation angles into a reference coordinate system, converting anisotropic voxels resolution of the sliced images to isotropic resolution, and fusing the sliced images into a final image.

This application is a Continuation-In-Part of application Ser. No. 12/336,306, filed Dec. 16, 2008.

### FIELD OF THE INVENTION

The invention relates in general to a microscopy system, and more particularly to a microscopy system having a revolvable stage.

### BACKGROUND OF THE INVENTION

Confocal laser scanning microscopy (CLSM or LSCM) is a valuable tool for obtaining high resolution images and 3-D reconstructions by using a spatial pinhole to eliminate out-of-focus light or flare. This technology permits one to obtain images of various Z-axis planes (Z-stacks) of the sample. The detected light originating from an illuminated volume element within the specimen represents one pixel in the resulting image. As the laser scans over the plane of interest, a whole image is obtained pixel by pixel and line by line. The beam is scanned across the sample in the horizontal plane using one or more (servo-controlled) oscillating mirrors. Information can be collected from different focal planes by raising or lowering the microscope stage. The computer can calculate and then generate a three-dimensional picture of the specimen by assembling a stack of these two-dimensional images from successive focal planes.

However, the Z-axis direction in the stacked 3D image has a much poor resolution (e.g., about 1.2 μm/slice) than in the X-axis and Y-axis directions (about 0.15 μm/pixel) under the limitation of the dimension of the pinhole and other mechanical or physical properties. A poor resolved Z-axis direction hampers the spatial reliability of the high resolution neural network images reconstructed, especially when comparison of two different samples is necessary. The same problem happens to the transmitted light microscope. One of the inventors, Ann-Shyn Chiang, has disclosed an aqueous tissue clearing solution in U.S. Pat. No. 6,472,216 B1. In the '216 patent, the depth of observation may reach the level of hundreds micrometers. In the currently developing method, fluorescent molecules are attached to or combined with the biological tissue. Thus, making the tissue become transparent is a key point for the break-through of the depth of observation, and the way of solving the bottleneck of the Z-axis resolution is greatly needed.

### SUMMARY OF THE INVENTION

It is therefore an object of the invention to provide a microscopy system with a revolvable stage for rotating a sample and holding the sample in a suitable situation so that enabling an image focusing module to acquire sliced images of the sample from different observation angles.

Another object of the invention is to provide a microscopy system with an image fusion unit for fusing a plurality of sliced images of the sample acquired from different observation angles into a final image with higher resolution.

Another object of the invention is to increasing the resolution of 3D image by means of fusing a plurality of sliced images of the sample acquired from different observation angles, especially increasing z-axis resolution of the 3D image of the sample.

It is a still further object of the invention to provide a microscopy system for increasing the depth resolution of the image by fusing two sliced images perpendicular to each other into one final image stack.

It is a further object of the invention to provide a microscopy system for fusing three-dimensional images to greater accuracy by means of image intensity remapping, resampling, three-dimensional table establishing, and tri-linear interpolation or non-linear interpolation.

The invention achieves the above-identified object by providing a microscopy system comprising an image focusing module and a stage for holding a sample. The image focusing module comprising at least one objective lens configured to collimate light radiated from the sample. The stage for supporting and/or holding a sample wherein the stage is revolvable around an axis which is substantially perpendicular to an extending direction from the sample to the image focusing module so that enabling the image focusing module to acquire sliced images of the sample from different observation angles. The microscopy system further comprises an image collecting unit for collecting the sliced images of the sample acquired by the image focusing module, and an image fusion unit for fusing the sliced images of the sample acquired from different observation angles, wherein the image fusion unit is coupled to the image collecting unit. The image fusion unit is used for fusing/remapping the sliced images acquired from different observation angles into a reference coordinate system, converting anisotropic voxels resolution of the sliced images to isotropic resolution, establishing a three-dimensional table with coordinate system indices, recording known image intensity of the sliced images into corresponding index location, calculating unknown image intensity on the corresponding coordinate system index location, and fusing the sliced images at different observation angles into the final image stack. The microscopy system further comprises a light input aperture, with or without a beam splitter, and a light output aperture. The beam splitter is substantially aligned with the light source, the light input aperture, the image focusing module and the stage, wherein the light source emits the light to the sample sequentially through the light input aperture, the beam splitter and the image focusing module. The light output aperture is for collecting the sliced images of the sample acquired by the image focusing module and substantially aligned with the beam splitter if necessary. When the light source illuminates the sample, the sample generates reflected/refracted or fluorescent light and the reflected/refracted or fluorescent light passes through the image focusing module and is reflected/refracted, by the beam splitter if necessary, to the image collecting unit for collecting the sliced images of the sample acquired by the image focusing module through the light output aperture.

In embodiments, the image collecting unit for collecting the sliced images of the sample acquired by the image focusing module is a photosensor for the purpose of collecting the sliced images of the sample acquired from different observation angles by the image focusing module. A storage medium coupled to the image collecting unit is configured to temporally store the sliced images. The image fusion unit uses one of the sliced images collected by said image collecting unit as a reference image, and defines the coordinate system of the reference image as a reference coordinate system. Then, the image fusion unit fuses/remaps another sliced images acquired from a different observation angle into the reference coordinate system.

After the sliced images have been remapped, the image fusion unit converts anisotropic voxels resolution of the remapped images to isotropic resolution. And then, the image fusion unit establishes a three-dimensional table with coordinate system indices corresponding to the converted isotropic images. The image intensity of the sliced images are recorded into the corresponding coordinate system index of the three-dimensional table, wherein the unknown image intensity on the corresponding coordinate system index is calculated by tri-linear interpolation based on the known image intensity of the neighboring sliced images as a reference. By means of tri-linear interpolation or non-linear interpolation, the sliced images are fused into a finally reconstructed image in high resolution.

The microscopy system disclosed in the present invention can be used in laser confocal microscopy or laser scanning confocal microscopy.

The remapping of the sliced images is implemented by means of Intensity-based registration.

The anisotropic voxel resolutions of the sliced images are converted to isotropic resolution by means of resampling techniques.

The recording known image intensity on the corresponding coordinate system index is implemented by joining, selecting and recording reliable grey level intensity value.

The unknown image intensity on the corresponding coordinate system index is calculated by tri-linear interpolation.

Further scope of the applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE FIGURES

The present invention will become more fully understood from the detailed description given hereinbelow and the accompanying drawings which are given by way of illustration only, and thus are not limitative of the present invention.

FIG. 1 is a schematic illustration showing a microscopy system according to a first embodiment of the invention.

FIG. 1A is a schematic illustration showing a transmitted light microscope according to a first embodiment of the invention.

FIG. 2 shows a first state of the microscopy system of FIG. 1.

FIG. 3 shows a second state of the microscopy system of FIG. 1.

FIG. 4 is a schematic illustration showing a microscopy system according to a second embodiment of the invention.

FIG. 5 shows an embodiment of a revolvable stage according to the invention.

FIG. 6 shows another embodiment of the revolvable stage according to the invention.

FIG. 7 shows an embodiment of a revolvable sample holder according to the invention.

FIG. 8 shows another embodiment of the revolvable sample holder according to the invention.

FIG. 9 shows an embodiment of collecting a first sliced image stack by the means of collecting according to the invention.

FIG. 10 shows an embodiment of collecting a second sliced image stack by the image collecting unit according to the invention.

FIG. 11 shows an embodiment of remapping the first sliced image stack and the second sliced image stack by the image fusion unit according to the invention.

FIG. 12 shows an embodiment of converting anisotropic voxels resolution of the sliced images to isotropic resolution by the means of resampling according to the invention.

FIG. 13 shows an embodiment of establishing a three-dimensional table with coordinate system indices according to the invention.

FIG. 14 shows an embodiment of recording image intensity of the sliced images into corresponding index location according to the invention.

FIG. 15 shows an embodiment of an established three-dimensional table according to the invention.

### DETAILED DESCRIPTION OF THE INVENTION

The present invention will be apparent from the following detailed description, which proceeds with reference to the accompanying drawings, wherein the same references relate to the same elements.

The present inventors have found that the sample may be rotated by a specific angle about an X-axis or a Y-axis so as to acquire segment images of the sample from different observation angles. Then, the image fusion may be performed by way of image processing in order to solve the problem of the too-low resolution in the Z-axis direction. In order to achieve this effect, a stage for supporting and holding the sample has to be configured to be revolvable. It is to be noted that the term “revolvable” means the revolvable angle ranges from 0 to 360 degrees, and this rotation may be out of the plane of the microscope platen. That is, the axis of rotation is not perpendicular to the plane of the microscope platen. The detailed structure of the microscopy system of the invention will be described in the following.

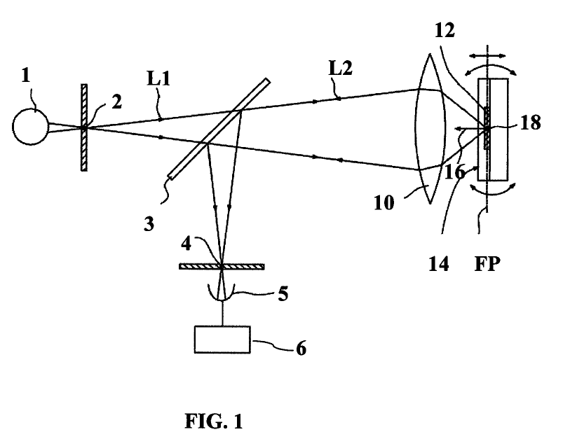

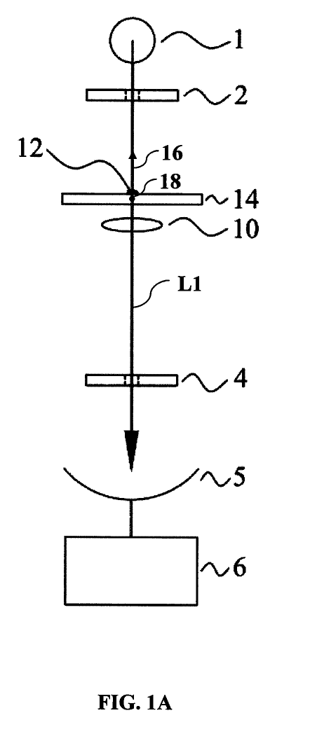

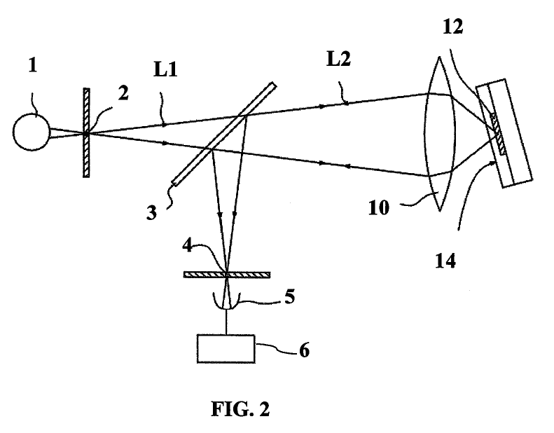

The present invention discloses a microscopy system. FIG. 1 is a schematic illustration showing a microscopy system according to a first embodiment of the invention. FIG. 2 shows a first state of the microscopy system of FIG. 1. FIG. 3 shows a second state of the microscopy system of FIG. 1. Referring to FIGS. 1 to 3, the microscopy system of this embodiment includes an image focusing module 10 and a stage 14 for holding a sample 12.

With reference to FIG. 1, the microscopy system of the present invention includes a light source 1, an illumination optical system, an image focusing module 10, a stage 14 for supporting a sample 12, an image collecting unit used for collecting the sliced images of the sample, and an image fusion unit 6 used for fusing a plurality of sliced images of the sample 12 acquired from different observation angles, wherein the image fusion unit 6 is coupled to the image collecting unit. In a preferred embodiment of the present invention, the image collecting unit is a photosensor 5. The light source 1 emits light L1 directed at the sample 12 and the illumination optical system comprising a light input aperture 2 configured to guide light L1 from the light source to the sample. The light input aperture 2 substantially aligned with the light source 1, the beam splitter 3, the image focusing module 10 and the stage 14. The light source 1 emits the light L1 to the sample 12 sequentially through the light input aperture 2, the beam splitter 3 and the image focusing module 10.

As shown in FIG. 1, the image focusing module 10 of the present invention comprising at least one objective lens is utilized to collimate the light L1 from the light source 1 and return light L2 from a sample, and acquire sliced images of the sample 12. In a preferred embodiment, the light output aperture 4 substantially aligned with the photosensor 5 and the beam splitter 3. Where the light source 1 illuminates the sample 12 to generate return light L2, for example reflected/refracted or fluorescent light from the sample 12, and the return light L2 passes through the image focusing module 10 and is reflected/refracted, by the beam splitter 3, to the photosensor 5 through the light output aperture 4.

In yet another preferred embodiment, as shown in FIG. 1A, the microscopy system of the present invention further comprises a transmitted light microscope. The invention can be configured without a beam splitter 3. The light source 1 substantially aligned with the light input aperture 2, the image focusing module 10, the stage 14 and the photosensor 5. The light L1 is emitted from the light source 1 to the photosensor 5 sequentially through the light input aperture 2, the stage 14, the image focusing module 10 and the light output aperture 4. In addition, the stage 14 used for supporting the sample 12 may also be configured to be movable along an extending direction 20 which extends from the light source 1 to the image focusing module 10.

The stage 14 is used for supporting the sample 12 and is configured to be revolvable about a rotational axis 18, which is substantially perpendicular to an extending direction 16 from the sample 12 to the image focusing module 10, as shown in FIGS. 2 and 3 (also see FIGS. 1 and 1A). The sample 12 may be, for example, a brain of an insect.

When being applied to the CLSM, the microscopy system may further include a light source 1, a light input aperture 2, a beam splitter 3, a light output aperture 4 and the photosensor 5. For example, the light source 1, such as a laser light source, outputs the incident light L1 to the sample 12 sequentially through the light input aperture 2, the beam splitter 3 and the image focusing module 10 so that reflected/refracted or fluorescent light L 2 is generated. The reflected/refracted or fluorescent light L 2 passes through the image focusing module 10 and is reflected, by the beam splitter 3, to the photosensor 5 through the light output aperture 4. In this embodiment, the light source 1 is aligned with the light input aperture 2, the beam splitter 3, the image focusing module 10 and the stage 14. The photosensor 5 is aligned with the light output aperture 4 and the beam splitter 3.

In one example, the stage 14 may also be configured to be movable along the extending direction 16. Therefore, the photosensor 5 may sense the sample 12 disposed on a focal plane FP so that the stage 14 can be moved along the extending direction 16, the sample 12 can be moved along the extending direction 16, and various images at various depths of the sample 12 may be located on the focal plane FP.

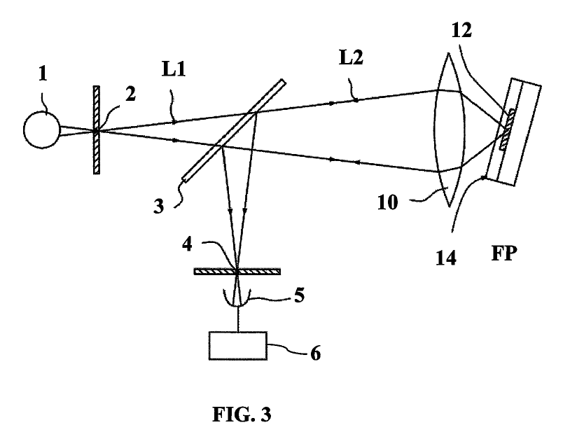

FIG. 4 is a schematic illustration showing a microscopy system according to a second embodiment of the invention. Referring to FIG. 4, the microscopy system of this embodiment further includes a movable stage 20 for supporting the stage 14. The movable stage 20 is configured to be movable along the extending direction 16. Consequently, the stage 14 needs not to have to be movable.

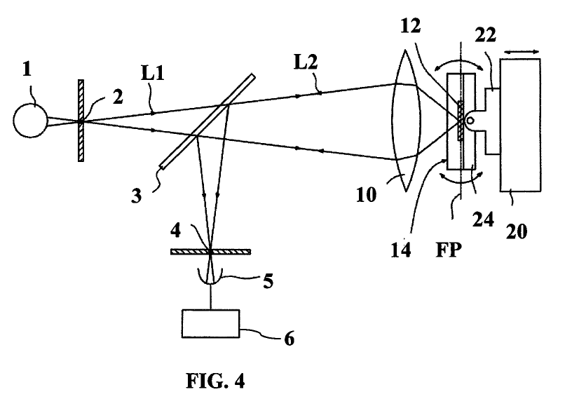

FIG. 5 shows an example of a revolvable stage according to the invention. In the first and second embodiments, the stage 14 may include a base 22 and a revolvable sample holder 24. The revolvable sample holder 24 for supporting the sample 12 is rotatably mounted on the base 22 through a pivot 23. For example, the revolvable sample holder 24 is a flat plate.

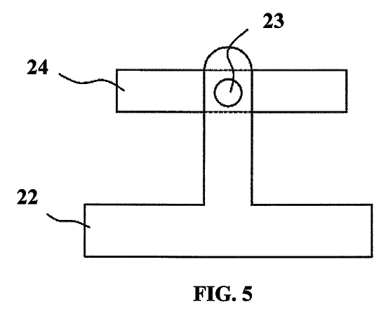

FIG. 6 shows another example of the revolvable stage according to the invention. Referring to FIG. 6, the stage 14 further includes a positioning mechanism 30 for positioning an observation angle of the revolvable sample holder 24 in a stepwise manner. In this example, the positioning mechanism 30 includes a wheel 31 and a pin 33. The wheel 31 is formed with a plurality of recesses 32. A supporting block 35 is fixed to the base 22 through a screw 36. A spring 34 is fixed to the supporting block 35 to push the pin 33. The pin 33 may be inserted into the recesses 32 so as to fix the wheel 31 at various rotating angles, respectively. The user can pull down the pin 33 to make the wheel 31 be revolvable. The wheel 31 and the revolvable sample holder 24 synchronously rotate through the pivot 23. The positioning mechanism 30 may position the revolvable sample holder 24 at two symmetrical rotating angles with respect to the extending direction 16. In another embodiment, the revolvable sample holder 24 may be rotated through a worm wheel and a worm shaft, or may be rotated by a motor.

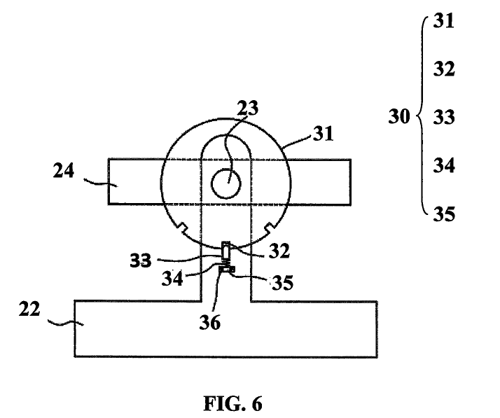

FIG. 7 shows an example of a revolvable sample holder according to the invention. Because the magnification power of the image focusing module in the high-magnification microscope is relatively high, the sample 12 has to be very close to the objective lens 10. The size of the stage 14, which is close to the objective lens 10, cannot be too large, or the rotating stage 14 may touch the objective lens 10 or even cannot be rotated. Thus, the invention is implemented as the architecture shown in FIG. 7, wherein the revolvable sample holder 24 is composed of two optical fibers 25, and the stage 14 is placed on the two optical fibers 25.

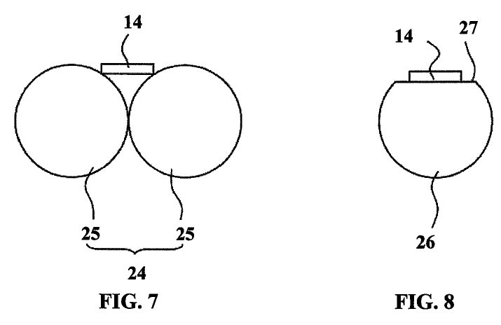

FIG. 8 shows another example of the revolvable sample holder according to the invention. As shown in FIG. 8, the revolvable sample holder 24 is composed of a cylinder 26, which is formed with a plane 27 to be in contact with the stage 14. The cylinder 26 may also be an optical fiber, for example.

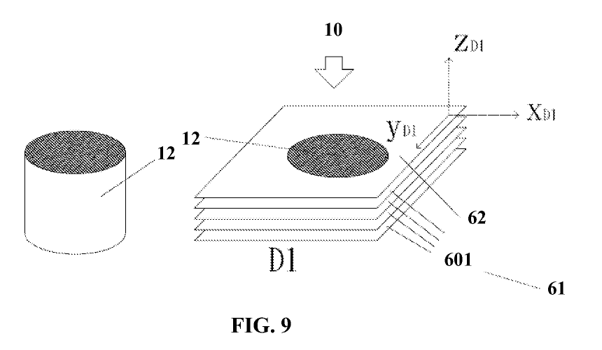

In one embodiment, as FIG. 9 shown, the photosensor 5 collects a first sliced image stack 61 (D1) with 3-dimensional resolution (x_{D1}, y_{D1}, z_{D1}) which is comprising a plurality of first sliced images 601 acquired by moving a first focal plane 62 (x_{D1}, y_{D1}) of the image focusing module 10 along z_{D1}-axis. In preferred embodiment, the z_{D1}-axis is oriented in the extending direction substantially perpendicular to one objective lens of the image focusing module 10.

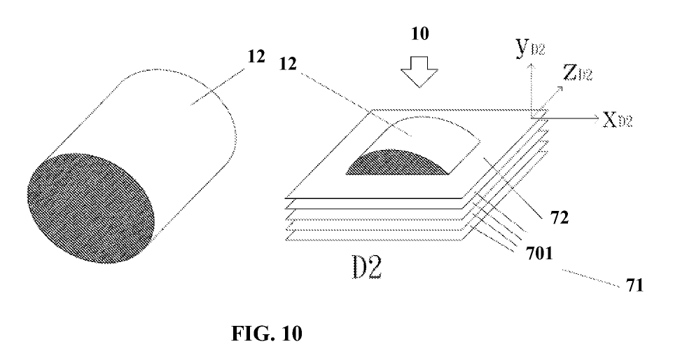

Then, the stage 14 is rotated around the rotational axis 18 with 90 degree in a counter-clockwise direction so that a second sliced image stack 71 (D2) of the sample 12 is acquired by the image focusing module 10 and collected by the photosensor 5. As FIG. 10 shown, the second sliced image stack 71 (D2) of the sample 12 is comprising a plurality of second sliced images 701 of the sample 12 which is theoretically perpendicular to the first sliced images 601 of the first sliced image stack 61(D1). It is noted that the stage 14 is revolvable around the rotational axis 18 from 0 to 360 degree in a clockwise and counter-clockwise direction, and the second sliced images and the first sliced images might be at an observation angle corresponding to the observation angle of the stage 14. The photosensor 5 then collects the second sliced image stack 71(D2) with 3-dimensional resolution (x_{D2}, y_{D2}, Z_{D2}). Then, the photosensor 5 sends the each collected image stack to the image fusion unit 6 for image fusing.

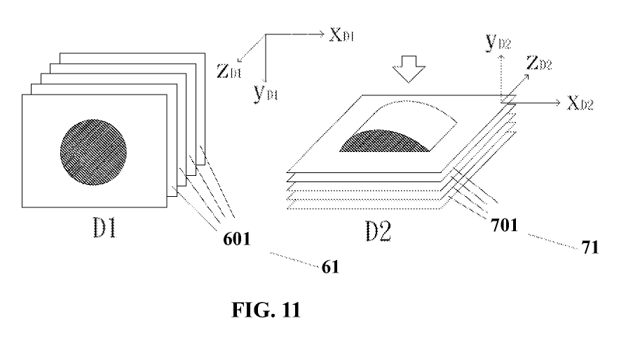

In the embodiment, as FIG. 11 shown, the image fusion unit 6 begins with selecting the first sliced image stack 61(D1) as a reference image, and defines the coordinate system of the first sliced image stack 61(D1) as a reference coordinate system. It may also be noted that the image fusion unit 6 may use any one of the sliced image stacks collected by said image collecting unit as a reference image, and defines the coordinate system of the reference image as a reference coordinate system. Then, the image fusion unit 6 remaps the second sliced image stack 71(D2) into the first sliced image stack 61(D1) in the reference coordinate system by means of Intensity-based registration. Finally, the image fusion unit 6 remaps the first sliced image stack 61(D1) and the second sliced image stack 71(D2) to the reference coordinate axis (x_{D1}).

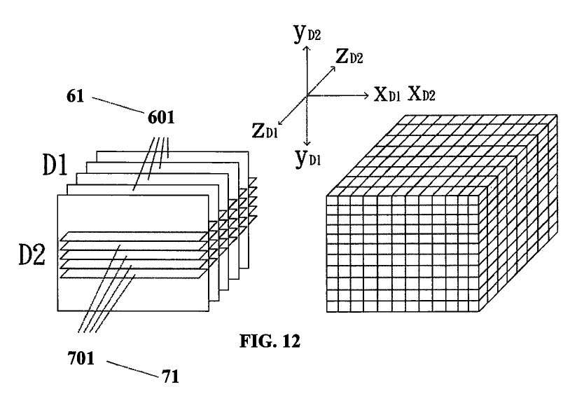

After the sliced images have been remapped, as FIG. 12 shown, the image fusion unit 6 converts anisotropic voxels resolution of the sliced images 601 of the first sliced image stack 61(D1) and the sliced images 701 of the second sliced image stack 71(D2) to isotropic resolution by means of resampling techniques. In this embodiment, resolution of the isotropic image is at (x₁, y₁, z₁).

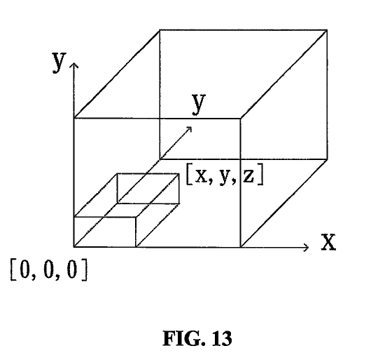

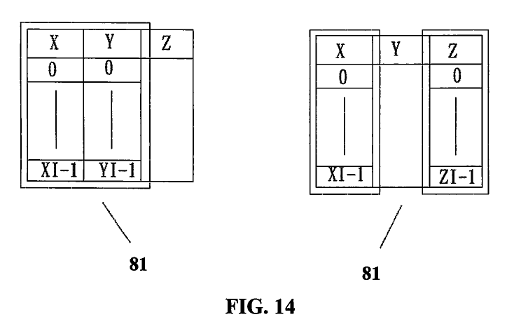

Referring to FIG. 13 and FIG. 14, the image fusion unit 6 then establishes a three-dimensional table 81 with coordinate system indices corresponding to the converted isotropic images. In the embodiment, the coordinate system indices are defined as [0 . . . (x₁−1), 0 . . . (y₁−1), 0 . . . (z₁−1)], wherein the index [0,0,0] is corresponding to the origin point of the reference coordinate system. Then, the image fusion unit 6 is used to compare the remapped, resampled images of the first sliced image stack 61(D1) and the remapped, resampled images of the first sliced image stack 71(D2).

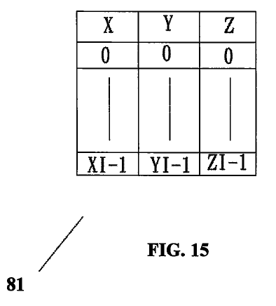

In the embodiment, while comparing the first sliced image stack 61(D1), the image fusion unit 6 is used to respectively record the exact image intensity of the In-plane into a corresponding index location based on the three-dimensional table 81, and the index locations corresponding to unknown image intensity remain vacant temporarily. Afterwards, the image fusion unit 6 is used to compare the second sliced image stack 71(D2) and record the exact image intensity of the In-plane into a corresponding index location. As regards the vacant index locations, the unknown image intensity are calculated by tri-linear interpolation or non-linear interpolation based on the known image intensity of the most neighboring voxel as a reference. In other words, the image fusion unit 6 is used to record the known image intensity of the images 601 of the first sliced image stack 61 (D1) and the images 701 of the second sliced image stack 71 (D2) into corresponding index locations, and the unknown image intensity on the corresponding coordinate system index is tri-linear interpolated or non-linear interpolated based on the known image intensity of the neighboring sliced images as a reference for the purpose of fusing/reassembling higher-resolution three-dimensional image, as shown in FIG. 15.

In the preferred embodiment, the image fusion unit 6 includes an image processing member. The image processing member comprises a processing unit, an image mapping unit for remapping the sliced images acquired from different observation angles into a reference coordinate system and an image mapping unit for reassembling the sliced images into a final image with high resolution. The present invention further comprises a storage medium coupled to the image collecting unit to store the sliced images.

The microscopy system with the revolvable stage according to the invention makes the sample be revolvable so that the image focusing module acquires the sliced images of the sample from different observation angles. In addition, different sliced image stacks are collected at different observation angles, such as 0 and 90 degrees, can be integrated. So, it is possible to fuse/reconstruct a three-dimensional image having the high resolution at three primary axes, and thus to implement other diversified image sensing functions. The image fusion unit 6 of the present invention is configured to record the known image intensity of the first sliced image stack and the second sliced image stack, which have been remapped and resampled, into the corresponding coordinate system index location of the three-dimensional table, and then, calculate the image intensity and index location of the unknown voxels by means of tri-linear interpolation or non-linear interpolation based the neighboring known image intensity as a reference. As a result, lost voxels of single image can be rebuilt and patched, and the depth resolution of the image can be increased. The accuracy to fuse three dimensional images in a microscope system is increased by the present invention.

While the invention has been described by way of examples and in terms of preferred embodiments, it is to be understood that the invention is not limited thereto. To the contrary, it is intended to cover various modifications. Therefore, the scope of the appended claims should be accorded the broadest interpretation so as to encompass all such modifications.

What is claimed is:

1. A microscopy system, comprising:
a light source for illuminating a sample;
an illumination optical system configured to guide light from the light source to the sample;
an image focusing module comprising at least one objective lens configured to collimate return light from the sample;
a stage for supporting a sample wherein the stage is revolvable around a rotational axis which is substantially perpendicular to an extending direction from the sample to the image focusing module and movable along the extending direction so that enabling the image focusing module to acquire sliced images of the sample from different observation angles;
an image collecting unit for collecting the sliced images of the sample acquired by the image focusing module; and
an image fusion unit for fusing the sliced images of the sample acquired from different observation angles, wherein the image fusion unit is coupled to the image collecting unit.

2. The microscopy system according to claim 1, wherein the microscopy system comprising a laser confocal microscopy system, a laser scanning confocal microscopy system or a transmitted light microscope.

3. The microscopy system according to claim 1, wherein the stage is configured to be movable three-dimensionally.

4. The microscopy system according to claim 1, further comprising a movable member disposed on the stage for supporting and providing three-dimensional movement of the stage.

5. The microscopy system according to claim 1, further comprising a revolvable member disposed on the stage for supporting and rotating the stage around the rotational axis.

6. The microscopy system according to claim 5, wherein the stage further comprises a positioning member for positioning the stage at an observation angle.

7. The microscopy system according to claim 1, wherein the image collecting unit is a photosensor.

8. The microscopy system according to claim 7, further comprising:
a light output aperture substantially aligned with the photosensor, wherein the light source illuminating the sample to generates reflected or fluorescent light from the sample, and the reflected or fluorescent light passes through the image focusing module and is transmitted to the photosensor through the light output aperture.

9. The microscopy system according to claim 8, wherein the illumination optical system comprising a light input aperture substantially aligned with the light source, the image focusing module, the stage, the light output aperture and the photosensor, wherein the light source emits the light to the photosensor sequentially through the light input aperture, the stage, the image focusing module and the light output aperture.

10. The microscopy system according to claim 8, further comprising a beam splitter which is substantially aligned with the light output aperture and the photosensor, wherein the reflected or fluorescent light from the sample passes through the image focusing module and is reflected, by the beam splitter, to the photosensor through the light output aperture.

11. The microscopy system according to claim 1, wherein the image collecting unit is used to collect a first sliced image stack comprising a plurality of first sliced images acquired by moving focal plane of the image focusing module along an optical axis, wherein the optical axis is oriented in the extending direction substantially perpendicular to the focal plane of the image focusing module; and sequentially collect a second image stack comprising a plurality of second sliced images acquired from an observation angle by moving focal plane of the image focusing module along the optical axis, wherein the observation angle is formed by revolving the stage around the rotational axis.

12. The microscopy system according to claim 11, wherein the observation angle may reach 90 degrees clockwise or counterclockwise from the first sliced image stack so that the second sliced images of the second image stack are perpendicular to the first sliced images of the first sliced image stack.

13. The microscopy system according to claim 11, wherein the image fusion unit further remaps the first sliced image stack and the second sliced image stack into a reference coordinate system, converts anisotropic voxels resolution of the first sliced images of the first sliced image stack and the second sliced images of the second sliced image stack to isotropic resolution, establishes a three-dimensional table with coordinate system indices corresponding to the sliced images that have been converted to isotropic resolution, records known image intensity of the sliced images into corresponding index location based on the three-dimensional table, then calculates unknown image intensity on the corresponding coordinate system index location based on the known image intensity of the neighboring sliced images as a reference, and then fuses the first sliced image stack and the second sliced image stack into a final image with higher resolution.

14. The microscopy system according to claim 13, wherein the reference coordinate system is defined by the coordinate system of the first sliced image stack.

15. The microscopy system according to claim 13, wherein the image fusion unit converts anisotropic voxels resolution of the sliced images to isotropic resolution by means of resampling techniques.

16. The microscopy system according to claim 13, wherein the unknown image intensity is calculated by means of tri-linear interpolation or non-linear interpolation.

17. The microscopy system according to claim 1, wherein the image fusion unit further comprising:
an image processing member, wherein the image processing member comprising a processing unit, an image mapping unit for remapping the sliced images acquired from different observation angles into a reference coordinate system, an image resampling unit for converting anisotropic voxels resolution of the sliced images to isotropic resolution, an image assembling unit for fusing the sliced images into a final image; and a storage medium coupled to the image collecting unit to store the sliced images.

18. The microscopy system according to claim 17, wherein the image mapping unit uses one of the sliced images as a reference image, defines the coordinate system of the reference image as a reference coordinate system, and remaps another sliced image into the reference image in the reference coordinate system.

19. The microscopy system according to claim 17, wherein the image mapping unit establishes a three-dimensional table with coordinate system indices corresponding to the sliced images with isotropic resolution, then records known image intensity of the sliced images into corresponding index location based on the three-dimensional table, and calculates unknown image intensity on the corresponding coordinate system index location based on the known image intensity of the neighboring sliced images as a reference.

20. The microscopy system according to claim 17, wherein the image mapping unit converts anisotropic voxels resolution of the sliced images to isotropic resolution by means of resampling techniques.

21. The microscopy system according to claim 18, wherein the image mapping unit remaps the sliced images acquired from different observation angles into the reference coordinate system by means of Intensity-based registration.

22. The microscopy system according to claim 18, wherein the image mapping unit reassembles the sliced images into a final image in high resolution by means of tri-linear interpolation or non-linear interpolation.

23. The microscopy system according to claim 19, wherein the image mapping unit records known image intensity of the sliced images into corresponding index location based on the three-dimensional table by joining, selecting and recording reliable grey level intensity value.

24. The microscopy system according to claim 19, wherein the image mapping unit calculates unknown image intensity on the corresponding coordinate system index location by means of tri-linear interpolation or non-linear interpolation.
